(19) United States
(12) Patent Application Publication
(10) Pub. No.: US 2009/0103125 A1
(43) Pub. Date: Apr. 23, 2009

(54) DECODING APPARATUS, IMAGE PROCESSING APPARATUS, RECORDING MEDIUM, AND DECODING METHOD

(75) Inventor: Yoshinori Awata, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 12/176,564

(22) Filed: Jul. 21, 2008

(30) Foreign Application Priority Data
Oct. 23, 2007 (JP) 2007274758

(51) Int. Cl. G06K 9/36; G06F 15/00

(52) U.S. Cl. 358/1.15; 382/233; 358/448

(57) ABSTRACT

An acquiring unit divides one line of image data in a main scan direction into blocks for every n consecutive pixels to acquire compressed pixel data generated by compressing each of the divided blocks. A first switching unit alternately switches a first or second data retaining unit defined as a write destination of the decompressed pixel data. A second switching unit alternately switches the first or second data retaining unit defined as a readout source of pixel data such that the pixel data are read out from the first or second data retaining unit not defined as the write destination of the pixel data by the first switching unit. A controller controls output of the pixel data from the first or second data retaining unit.

### CROSS-REFERENCE TO RELATED APPLICATIONS

This application is based on and claims priority under 35 USC 119 from Japanese Patent Application, No. 2007-274758 filed on Oct. 23, 2007.

### BACKGROUND

1. Technical Field

The present invention relates to a decoding apparatus, an image processing apparatus, a recording medium, and a decoding method.

2. Related Art

When a computer user transmits print data to a printer for printing, a computer often transmits print data after compressing the data in accordance with a predetermined compression mode to reduce a data transmission amount. However, the printer performs a process of decompressing and decoding the compressed data before printing.

Recent printers have more advanced functions and not only print original images directly but also can execute image edit processes such as the mirror image printing that interchanges left and right of original images and the shift printing that shifts original images to the left or right. Such image edit processes can easily be provided by utilizing a line buffer for the image edit processes.

However, to implement the image edit process such as the mirror image printing in the convention case, the line buffer for the image edit process is necessary in addition to a line buffer for the decompress process and, therefore, the production cost is increased.

### SUMMARY

According to an aspect of the invention, there is provided a decoding apparatus including an acquiring unit that divides one line of image data in a main scan direction into blocks for every n consecutive pixels (n is a positive integer not smaller than two) to acquire compressed pixel data generated by compressing each of the divided blocks; a decompressing unit that decompresses the acquired compressed pixel data on the basis of the blocks; first and second data retaining units that retain the decompressed one-line pixel data; a first switching unit that alternately switches the first or second data retaining unit defined as a write destination of the pixel data decompressed by the decompressing unit; a second switching unit that alternately switches the first or second data retaining unit defined as a readout source of pixel data such that the pixel data are read out from the first or second data retaining unit not defined as the write destination of the pixel data by the first switching unit; an output unit that outputs the pixel data read by the second switching unit; and a controller that controls output of the pixel data from the first or second data retaining unit, each of the data retaining units including a memory that has pixel data stored thereon, a writing unit that writes into the memory the pixel data output from the decompressing unit in accordance with a write instruction from the first switching unit, a first readout processing unit that reads the pixel data stored in the memory in accordance with a readout instruction excluding the write instruction from the first switching unit, and a second readout processing unit that reads from the memory the pixel data corresponding to an instruction from the controller in accordance with the readout instruction from the first switching unit to output the pixel data to the second switching unit, the decompressing unit referring to the pixel data read by the first readout processing unit to decompress the compressed pixel data.

### BRIEF DESCRIPTION OF THE DRAWINGS

Exemplary embodiments the present invention will be described in detail based on the following figures, wherein:

FIG. 1 illustrates a configuration of hardware of an image processing apparatus of a first exemplary embodiment;

FIG. 2 is a block diagram of a configuration of a decoding apparatus of the first exemplary embodiment;

FIG. 3 is a timing chart of a decoding apparatus of the first exemplary embodiment;

FIG. 4 illustrates a configuration of a line buffer forming a data retaining unit of the first exemplary embodiment;

FIG. 5 illustrates a configuration of a line buffer forming a data retaining unit of a second exemplary embodiment;

FIG. 6 is a block diagram of a configuration of a decoding apparatus of a third exemplary embodiment;

FIG. 7 is a conceptual view of blocks stored in the data retaining unit for explaining features of the third exemplary embodiment; and

FIG. 8 is a conceptual view of blocks stored in the data retaining unit for explaining features of a fourth exemplary embodiment.

### DETAILED DESCRIPTION

Exemplary embodiments of the present invention will hereinafter be described with reference to the drawings.

### First Exemplary Embodiment

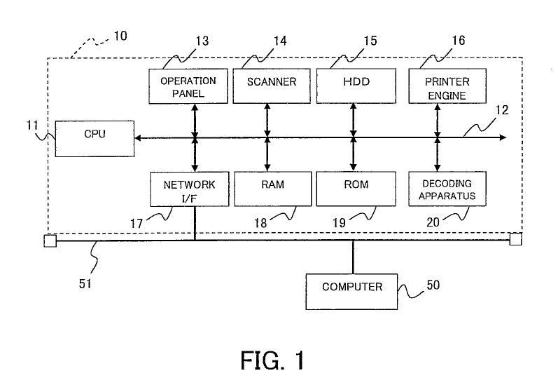

FIG. 1 depicts an example of a hardware configuration of an image processing apparatus 10 according to the present invention. The image processing apparatus 10 of this exemplary embodiment is a multi-function device equipped with a print function and a copy function that implement various functions such as the mirror image printing and the shift printing and is an apparatus with a built-in computer. In FIG. 1, a CPU 11 controls operations of various mechanisms mounted on the apparatus, such as a scanner 14 and a printer engine 16, in accordance with a program stored in a ROM 19. An address data bus 12 is connected to various mechanisms to be controlled by the CPU 11 for data communication. An operation panel 13 accepts instructions from users such as instructions for the mirror image printing and the shift printing and displays information. A scanner 14 scans a manuscript set by user and stores it as electronic data in storage such as an HDD (hard disk drive) 15. The HDD 15 stores electronic documents and the like that is scanned via the scanner 14. The printer engine 16 prints an image on an output paper sheet in accordance with an instruction from a control program executed by the CPU 11. A network interface (I/F) 17 connects with a network 51 and is utilized for data transmission/reception such as reception of print images transmitted from the computer 50 to this apparatus. A RAM 18 is utilized as a work memory at the time of execution of programs or a communication buffer at the time of transmission/reception of electronic data. The ROM 19 stores various programs related to the operation control, etc., of this apparatus. A decoding apparatus 20 decodes a compressed image into an original image when image data sent from the computer as a print target are compressed.

In this exemplary embodiment, for pixel data making up an original image to be printed, a block is generated for each of n pieces of pixel data successive in a main scan direction, and the pixel data are compressed on the basis of the blocks. Since the compression cannot be performed if n is one, n is a positive integer not smaller than two. That is, the line data of the original image in the main scan direction are made up of m (m is a natural number) pieces of n-byte fixed-length blocks. The computer 50 uses a coding unit to execute the data compression process and transmits data to the image processing apparatus 10 along with a print instruction. In this exemplary embodiment, the pixel data are converted into code data on the basis of the blocks with the use of a compression mode of lossless compression. The pixel data coded by the data compression have variable length. The compressed image data sent from the computer 50 to the image processing apparatus 10 include information about compression, in other words, information necessary for decoding the compressed data. Specifically, the included information is command identification information (code identifier) indicating what command is used for each block when coding the pixel data included in the block, the pixel data (code data) coded by the compression in accordance with a compression method indicated by the command, a code data length, etc. Particularly, it is assumed that a compression method employed in this exemplary embodiment is provided with a compression instruction (command) for one block, which is a command indicating that the compression method is the same as the directly overhead block included in the preceding line. Since each of the main scan direction lines making up image data includes the same number of blocks, the “directly overhead block” is a block located at the same arrangement order in the one last decompressed line.

The image processing apparatus 10 receives the image data to be printed sent from the computer 50 through the network interface 17 and temporarily retains the data in the RAM 18. Although the image processing apparatus 10 instructs the printer engine 16 to perform printing, if the image data to be printed are compressed image data converted into code data, the image processing apparatus 10 gives an instruction for printing after decoding the compressed image data into the original image with the use of the decoding apparatus 20. The image processing apparatus 10 performs the mirror image printing by inverting the original image or performs the shift printing by shifting a print start position in accordance with user's instructions input from the operation panel 13, etc.

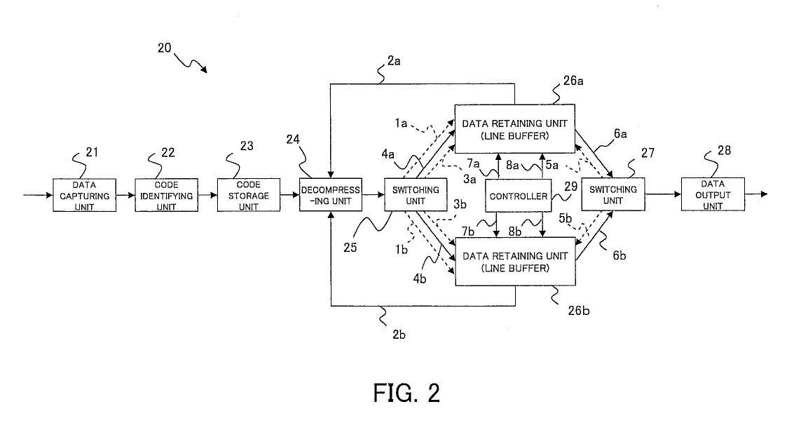

FIG. 2 is a block configuration view of the decoding apparatus 20 of this exemplary embodiment. In FIG. 2, a data capturing unit 21 takes out the compressed image data to be decoded from the RAM 18 in order to capture the data into the decoding apparatus 20. A code identifying unit 22 analyzes the compressed image data of one line captured by the data capturing unit 21 to extract the code identifiers and the code data from the compressed image data of the blocks making up the line. A code storage unit 23 has stored the code identifiers and the code data extracted by the code identifying unit 22.

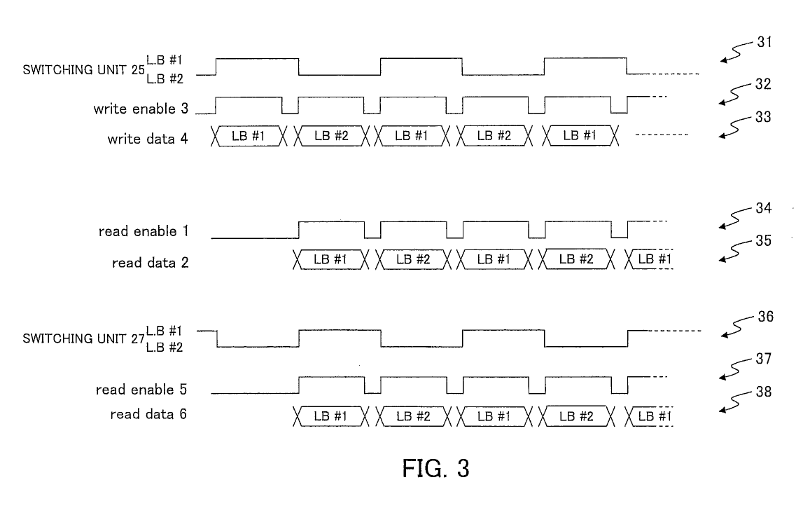

A decompressing unit 24 sequentially refers to the code data of the blocks stored in the code storage unit 23 to perform decompression into the original pixel data as described later. The pixel data of one line by the decompressing unit 24 are sent out and retained by one of data retaining units 26a and 26b, and a switching unit 25 alternately switches the data retaining units 26a and 26b to determine the destination. The data retaining units 26a and 26b are made up of line buffers having at least one-line data length after the decoding. The data output unit 28 outputs the pixel data retained in one of the data retaining units 26a and 26b through the network 51, and a switching unit 27 alternately switches the data retaining units 26a and 26b retaining the pixel data to be output. A controller 29 performs overall control of the decoding process in the decoding apparatus 20. Specific details of the switching control by the switching units 25, 27 and the control by the controller 29 will be described later. Signal lines 1 to 6 are signal lines transmitting various control signals 32, 34, 37 and various data signals 33, 35, 38 shown in FIG. 3 described later, and the control signal lines 1, 3, 5 and the data signal lines 2, 4, 6 are shown by dash lines and solid lines, respectively. Signal lines 7, 8 are signal lines connected with the controller 29 to send out instruction information for the image edit process such as the read positions of the pixel data to the data retaining units 26. In FIG. 2, details common to a pair of the data retaining units 26a and 26b are described with the term “data retaining units 26” with the exclusion of “a” and “b”. This also applies to the signal lines 1 to 8 and other figures.

The functions of the decoding apparatus 20 are implemented by circuits built into the decoding apparatus 20. The functions of the decoding apparatus 20 may be configured to be implemented with programs. In this case, other than the code storage unit 23 and the data retaining units 26 having data stored thereon, the constituent elements 21, 22, 24, 25, 27, 28, 29 of the decoding apparatus 20 are implemented by coordinated operations of the computer mounted on the image processing apparatus 10 and programs operated by the CPU 11 mounted on the computer. The decoding apparatus may be mounted on DFE (digital front end) provided on the outside of the printer engine 16. The decoding apparatus may be connected through a general-purpose bus such as the PCI or the PCI express.

The programs to be used in this exemplary embodiment can be provided through a communicating unit, and can also be provided by being stored on a computer-readable recording medium such as CD-ROM and DVD-ROM. The programs provided through the communicating unit or the recording medium are installed in the computer mounted on the image processing apparatus 10 and the various processes are implemented by sequentially executing the installed programs with the CPU 11 of the computer.

The operation of decoding a compressed image by the decoding apparatus 20 in this exemplary embodiment will then be described.

When the compressed image data to be printed are sent to the image processing apparatus 10 and temporarily retained in the RAM 18, the data capturing unit 21 sequentially takes out from the RAM 18 the compressed image data one-line data at a time from the beginning. The one-line data taken out by the data capturing unit 21 include the compressed image data of plural blocks, and the code identifying unit 22 extracts and sends out a code identifier and code data from each of the blocks of the compressed image data to the code storage unit 23. As a result, the code identifiers and the code data of the blocks are stored in the code storage unit 23. The decompressing unit 24 and the switching units 25, 27 decompress the compressed pixel data in synchronization with each other under the operational control of the controller 29 as follows.

FIG. 3 depicts a timing chart of the decoding apparatus 20 of this exemplary embodiment. The controller 29 sends a synchronization signal not shown to the constituent elements included in the decoding apparatus 20. The decompressing unit 24 and the switching units 25, 27 operated in synchronization with each other in accordance with this synchronization signal. The switching unit 25 switches Hi and Lo of a switch signal internally generated, as shown in FIG. 3. In this exemplary embodiment, when the switch signal 31 is Hi, the switching is performed to a line buffer (LB) #1 making up the data retaining unit 26a, and when the switch signal 31 is Lo, the switching is performed to a line buffer (LB) #2 making up the data retaining unit 26b. Data can be written into only one of the data retaining unit 26a and the data retaining unit 26b selected by this switching control. The switching unit 25 sends out a write control signal 32 for a write instruction. Although the write control signal 32 is sent out concurrently with the switch signal 31 in this exemplary embodiment, since Hi and Lo of the switch signal 31 is switched at predetermined periods, the write control signal 32 is alternately sent out to the data retaining unit 26a and the data retaining unit 26b. That is, the one-line pixel data sent out from the decompressing unit 24 are alternately sent to the data retaining unit 26a and the data retaining unit 26b. The predetermined periods may be determined depending on the processing performance of the decoding apparatus 20 and the length of data written into and read from the data retaining units 26. As above, the data retaining units 26 alternately retain the pixel data 33 sent out from the decompressing unit 24 in synchronization with the write control signal 32 sent out in accordance with the switching control of the switching unit 25.

While sending out the pixel data 33 for each of the predetermined periods, the decompressing unit 24 utilizes the pixel data of a directly overhead block included in the one last decompressed line when decompressing the pixel data of each block. Since the data retaining unit 26 defined as the write destination is alternately switched by the switching unit 25, the last decompressed pixel data must be stored in the data retaining unit 26 currently not subjected to the writing. Therefore, the switching unit 25 sends out the readout control signal 34 to the data retaining unit 26 to which the write control signal 32 is not sent out. Therefore, the decompressing unit 24 acquires for each period the last written pixel data 35 from the data retaining unit 26b or the data retaining unit 26a opposite to the data retaining unit 26a or the data retaining unit 26b having the pixel data 33 currently being written.

On the other hand, the switching unit 27 switches Hi and Lo of an internally generated switch signal 36 for each predetermined period in accordance with the synchronization signal. The switch signal 36 is used in the same way as the switch signal 31 and data can be written into only the data retaining unit 26 selected by the switching control. The decompressed pixel data are sent out by the data output unit 28 and retained in the RAM 18, and the data retaining unit 26 serving as the source of the decompressed pixel data is the data retaining unit 26 currently not subjected to the writing. Therefore, the switching unit 27 sends out the readout control signal 37 to the data retaining unit 26 not subjected to the writing in accordance with the write control signal 32. Therefore, the data output unit 28 reads out for each period the last written pixel data 38 from the data retaining unit 26b or the data retaining unit 26a opposite to the data retaining unit 26a or the data retaining unit 26b having the pixel data 33 currently being written.

The decompressing process of the decompressing unit 24 will then be described.

The decompressing unit 24 reads respective code data corresponding to plural blocks from the code storage unit 23 in order and decodes the code data to decompress the compressed pixel data. If the compressed image data of the block include an identifier of a compression instruction command indicating that compression is performed in the same mode as the directly overhead block, the decompressing unit 24 does not decode the code data of the block to be decompressed and utilizes the pixel data corresponding to the directly overhead block among the one-line pixel data sent from the signal line 2 as the pixel data acquired by decompressing the compressed pixel data in the block. In this way, the decompressing unit 24 acquires the decompressed pixel data without decoding the code data generated through encoding. The decompressed pixel data of the block acquired in this way are sent through the switching unit 25 and retained in the data retaining units 26 as above.

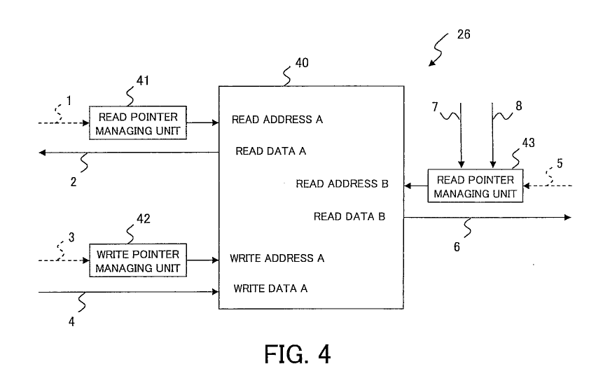

FIG. 4 is a configuration view of a line buffer making up the data retaining unit 26 of this exemplary embodiment. The line buffer 26 is a three-port RAM having two readout ports and one write port. The line buffer 26 includes a memory 40 with a capacity capable of retaining one-line pixel data after decompression, a read pointer managing units 41, 43 that manage storage positions of the pixel data to be read at the read ports, and a write pointer managing unit 42 that manages a write position of the pixel data at the write port. Reference numerals 1 to 8 given to the signal lines correspond to the reference numerals shown in FIGS. 2 and 3.

First, the write pointer managing unit 42 makes up a writing unit in conjunction with the signal lines 3 and 4. The write pointer managing unit 42 initializes a pointer indicating a writing position when starting the writing of pixel data of a new line. The pointer is normally initialized to a leading address of the memory 40 used for storage of the pixel data. When the pixel data 33 are sent from the data signal line 4 at the same time as the write control signal 32 is input from the write control signal line 3, the write pointer managing unit 42 updates the pointer in conformity to the writing of the pixel data 33 into the memory 40.

The read pointer managing unit 41 makes up a readout processing unit in conjunction with the signal lines 1 and 2. The read pointer managing unit 41 initializes a pointer indicating a reading position when starting the readout of pixel data of a new line. The pointer is normally initialized to an address of the memory 40 where the foremost pixel data is stored. When the readout control signal 34 is input from the readout control signal line 1, the read pointer managing unit 41 reads the pixel data 35 stored at the address indicated by the pointer from the memory 40. When the read pixel data are sent out from the data signal line 2, the read pointer managing unit 41 updates the pointer in conformity to the readout.

The read pointer managing unit 43 makes up a second readout processing unit in conjunction with the signal lines 5 and 6. The read pointer managing unit 43 initializes the pointer at the address on the memory 40 corresponding to the readout instruction from the controller 29 at the same time as the readout control signal 37 is input from the readout control signal line 5. That is, when a signal indicating the data read out through a last-in first-out method (LIFO) is sent from the controller 29 through the signal line 7, the read pointer managing unit 43 initializes the pointer to the address position of the rearmost pixel data stored in the memory 40. The pixel data are sequentially read out from the rearmost pixel data to the foremost pixel data and when the pixel data are sent out from the data signal line 6, the read pointer managing unit 43 updates the pointer in conformity to the readout. The pixel data read out mode through LIFO is suitable for the case of the mirror image printing. When a data signal indicating an address is sent from the controller 29 through the signal line 8, the read pointer managing unit 43 initializes the pointer to the address position on the memory 40. The pixel data are sequentially read out from the pointer position to the rearmost pixel data and when the pixel data are sent out from the data signal line 6, the read pointer managing unit 43 updates the pointer in conformity to the readout. This pixel data readout mode staring in the middle of one line is suitable for the case of the shift printing.

As described with reference to FIGS. 3 and 4, the pixel data retained in the data retaining unit 26 are sent from the first readout processing unit to the decompressing unit 24 to be utilized for the pixel data decompressing process at the same time as the data are output from the second readout processing unit.

### Second Exemplary Embodiment

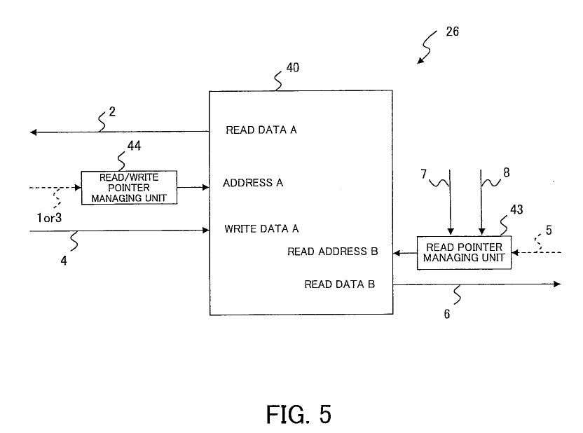

FIG. 5 is a configuration view of the line buffer 26 of this exemplary embodiment. Although the line buffer 26 is implemented with a three-port memory in the first exemplary embodiment, the line buffer 26 is implemented with a two-port memory, which is inexpensive, in this exemplary embodiment.

The readout control signal 34 output from the switching portion 25 is always sent out to the line buffer 26 different from the line buffer 26 to which the write control signal 32 sent out. That is, since the writing operation and the readout operation of the pixel data are exclusive to each other, the operation same as the first exemplary embodiment may be performed by providing one read/write pointer managing unit 44 as in this exemplary embodiment without separately providing the read pointer managing unit 41 and the write pointer managing unit 42 as is the case with the first exemplary embodiment. That is, the read/write pointer managing unit 44 initializes the pointer indicating a writing position when starting the readout/writing of pixel data of a new line. For example, as exemplarily illustrated in FIG. 5, when the pixel data 33 are sent from the data signal line 4 at the same time as the write control signal 32 is input from the write control signal line 3, the read/write pointer managing unit 44 updates the pointer in conformity to the writing of the pixel data 33 into the memory 40. Subsequently, if the write control signal 32 is not input from the write control signal line 3, it can be considered that the readout control signal 34 is input and, therefore, when the pixel data 35 stored at the address indicated by the pointer are read from the memory 40 and are sent out from the data signal line 2, the read/write pointer managing unit 44 updates the pointer in conformity to the readout.

On the other hand, if the readout control signal line 1 is connected to the read/write pointer managing unit 44, when the readout control signal 34 is not input from the readout control signal line 1, it can be considered that the write control signal 32 is input and, therefore, the read/write pointer managing unit 44 updates the pointer in conformity to the writing into the memory 40 of the pixel data 33 sent from the data signal line 4. If the readout control signal 34 is subsequently input from the readout control signal line 2, when the pixel data 35 stored at the address indicated by the pointer are read from the memory 40 and are sent out from the data signal line 2, the read/write pointer managing unit 44 updates the pointer in conformity to the readout.

Since the writing and the readout of the pixel data are alternately performed as above, at least one of the write control signal 32 and the readout control signal 34 may be input to the line buffer 26.

### Third Exemplary Embodiment

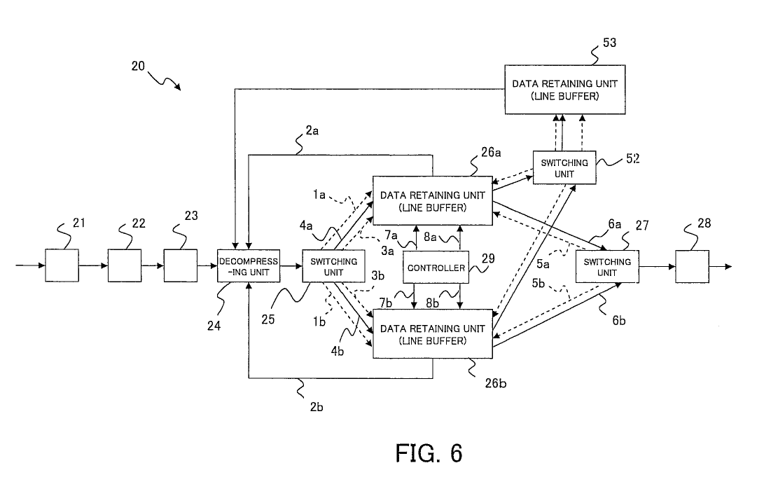

FIG. 6 is a block configuration view of the decoding apparatus 20 of this exemplary embodiment. The decoding apparatus 20 of this exemplary embodiment has a configuration of the first exemplary embodiment with a switching unit 52 and a data retaining unit 53 added. The data retaining unit 53 may have the configuration same as the data retaining unit 26 and is made up of a line buffer retaining one line of decompressed pixel data. The switching unit 52 alternately switches the data retaining units 26a and 26b retaining the pixel data to be output as is the case with the switching unit 27. The data retaining unit 26 retains the last decompressed pixel data, and the data retaining unit 53 retains the pixel data retained by the data retaining unit 26. That is, the data retaining unit 26 retains the pixel data decompressed one step before while the data retaining unit 53 retains the pixel data decompressed two steps before.

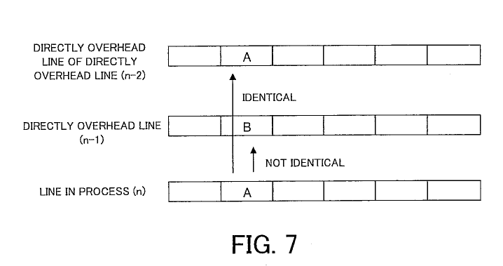

FIG. 7 is a conceptual view of blocks stored in the data retaining unit for explaining features of the this exemplary embodiment; the lower part shows the data retaining unit 26a (or 26b) being in the writing process; the intermediate part shows the data retaining unit 26b (or 26a) having the data written at the previous time; and the upper part shows the data retaining unit 53 having the data written before the previous time. Although the decompressing unit 24 of the first exemplary embodiment is configured to read the last decompressed line from the data retaining unit 26 and to refer to a directly overhead block when performing the decompressing process, the decompressing unit 24 of this exemplary embodiment is configured to also read and refer to the pixel data decompressed two steps before from the data retaining unit 53. Therefore, even when a directly overhead block B included in the last decompressed line cannot be utilized since the directly overhead block B is not identical to a block A to be decompressed, if the block A is identical to a block A included in the line decompressed before the previous time, i.e., the directly overhead block A of the directly overhead block B, the pixel data thereof are utilized.

### Fourth Exemplary Embodiment

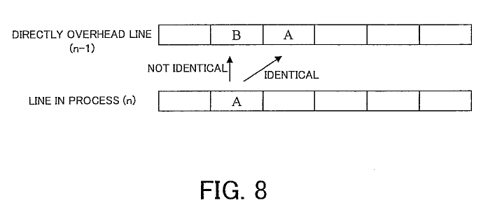

FIG. 8 is a conceptual view of blocks stored in the data retaining unit 26 for explaining features of the this exemplary embodiment; the lower part shows the data retaining unit 26a (or 26b) being in the writing process; and the upper part shows the data retaining unit 26b (or 26a) having the data written at the previous time.

Although the decompressing unit 24 of the first exemplary embodiment is configured to read the last decompressed line from the data retaining unit 26 and to refer to a directly overhead block, the decompressing unit 24 of this exemplary embodiment refers to a block at the periphery of the directly overhead block. That is, even when the directly overhead block B included in the last decompressed line cannot be utilized since the directly overhead block B is not identical to the block A to be decompressed, if the block A is identical to a block A at the periphery of the directly overhead block B, the pixel data thereof are utilized. Although the block on the subsequent stage adjacent to the directly overhead block B is referenced since this block is identical in the case of FIG. 8, the referenced block is not limited to the block adjacent to the directly overhead block and the next adjacent block may be referenced. As above, the decompressed pixel date may be utilized to acquire the decompressed pixel data without actually executing the decompressing process for a block to be decompressed. The extent of the range of blocks adjacent to the directly overhead block is determined depending on trade-off between the referencing process and the process of actually decoding code data.

The above exemplary embodiments may be implemented in combination as needed. Although the case of applying the decoding apparatus 20 to the image processing apparatus 10 has been described as an example in the above exemplary embodiments, the decoding apparatus 20 may be applied not only to the image processing apparatus 10 and may be built into and implemented with any apparatus as long as the apparatus must decompress the compressed pixel data. The decoding apparatus 20 may be provided as an independent apparatus.

Although it is basically assumed that the compression mode for the image data to be printed is the lossless compression mode in the above exemplary embodiments, the present invention may be applied to the lossy compression mode when possible.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A decoding apparatus comprising:
an acquiring unit that divides one line of image data in a main scan direction into blocks for every n consecutive pixels (n is a positive integer not smaller than two) to acquire compressed pixel data generated by compressing each of the divided blocks;
a decompressing unit that decompresses the acquired compressed pixel data on the basis of the blocks;
first and second data retaining units that retain the decompressed one-line pixel data;
a first switching unit that alternately switches the first or second data retaining unit defined as a write destination of the pixel data decompressed by the decompressing unit;
a second switching unit that alternately switches the first or second data retaining unit defined as a readout source of pixel data such that the pixel data are read out from the first or second data retaining unit not defined as the write destination of the pixel data by the first switching unit;
an output unit that outputs the pixel data read by the second switching unit; and
a controller that controls output of the pixel data from the first or second data retaining unit,
each of the data retaining units including
a memory that has pixel data stored thereon,
a writing unit that writes into the memory the pixel data output from the decompressing unit in accordance with a write instruction from the first switching unit,
a first readout processing unit that reads the pixel data stored in the memory in accordance with a readout instruction excluding the write instruction from the first switching unit, and
a second readout processing unit that reads from the memory the pixel data corresponding to an instruction from the controller in accordance with the readout instruction from the first switching unit to output the pixel data to the second switching unit,
the decompressing unit referring to the pixel data read by the first readout processing unit to decompress the compressed pixel data.

2. The decoding apparatus of claim 1, wherein
the controller sends to the second readout processing unit an instruction of reading pixel data in a last-in first-out method.

3. The decoding apparatus of claim 1, wherein
the controller sends a readout start position of pixel data in the memory as an instruction to the second readout processing unit.

4. The decoding apparatus of claim 1, comprising
a third data retaining unit that retains the decompressed one-line pixel data, and
a third switching unit that perform switchover to the first or second data retaining unit not defined as a write destination of pixel data by the first switching unit to read and output the pixel data from the data retaining unit to the third data retaining unit, wherein
the decompressing unit acquires pixel data decompressed at the previous time from the first or second data retaining unit and pixel data decompressed immediately before the previous time from the third data retaining unit and refers to the acquired pixel data to decompress the compressed pixel data.

5. The decoding apparatus of claim 1, wherein
the decompressing unit refers to decompressed pixel data from a block located at the same order as the block to be decompressed or decompressed pixel data from a block at the periphery of the block located at the same order among the pixel data read by the first readout processing unit to decompress the compressed pixel data.

6. The decoding apparatus of claim 1, wherein
the first and second data retaining units are three-port memories capable of independently performing a readout operation and a writing operation.

7. The decoding apparatus of claim 1, wherein
the first and second data retaining units are two-port memories having a common port serving as a data input port of the writing unit and a data output port of the first readout processing unit.

8. An image processing apparatus comprising:
a decoding apparatus;
a unit that accepts image data to be printed;
a decode instructing unit that instructs the decoding apparatus to decode the image data if the image data to be printed are compressed; and
an image processing unit that processes image data output from the decoding apparatus,
the decoding apparatus including
an acquiring unit that divides one line of image data in a main scan direction into blocks for every n consecutive pixels (n is a positive integer not smaller than two) to acquire compressed pixel data generated by compressing each of the divided blocks,
a decompressing unit that decompresses the acquired compressed pixel data on the basis of the blocks,
first and second data retaining units that retain the decompressed one-line pixel data,
a first switching unit that alternately switches the first or second data retaining unit defined as a write destination of the pixel data decompressed by the decompressing unit,
a second switching unit that alternately switches the first or second data retaining unit defined as a readout source of pixel data such that the pixel data are read out from the first or second data retaining unit not defined as the write destination of the pixel data by the first switching unit,
an output unit that outputs the pixel data read by the second switching unit; and
a controller that controls output of the pixel data from the first or second data retaining unit,
each of the data retaining units including
a memory that has pixel data stored thereon;
a writing unit that writes into the memory the pixel data output from the decompressing unit in accordance with a write instruction from the first switching unit,
a first readout processing unit that reads the pixel data stored in the memory in accordance with a readout instruction excluding the write instruction from the first switching unit, and
a second readout processing unit that reads from the memory the pixel data corresponding to an instruction from the controller in accordance with the readout instruction from the first switching unit to output the pixel data to the second switching unit,
the decompressing unit referring to the pixel data read by the first readout processing unit to decompress the compressed pixel data.

9. A recording medium storing a decoding program causing a computer to execute a process, the process comprising:
dividing one line of image data in a main scan direction into blocks for every n consecutive pixels (n is a positive integer not smaller than two) to acquire compressed pixel data generated by compressing each of the divided blocks;
decompressing the acquired compressed pixel data on the basis of the blocks;
retaining the one-line decompressed pixel data in first and second data retaining units;
alternately switching the first or second data retaining unit defined as a write destination of the decompressed pixel data;
alternately switching the first or second data retaining unit defined as a readout source of pixel data such that the pixel data are read out from the first or second data retaining unit not defined as the write destination of the pixel data;
outputting the pixel data read from the first or second data retaining unit; and
referring to the pixel data read out from the first or second data retaining unit not defined as the write destination of the decompressed pixel data when decompressing the acquired compressed pixel data on the basis of the blocks.

10. A decoding method comprising:
dividing one line of image data in a main scan direction into blocks for every n consecutive pixels (n is a positive integer not smaller than two) to acquire compressed pixel data generated by compressing each of the divided blocks;
decompressing the acquired compressed pixel data on the basis of the blocks;
retaining the decompressed one-line pixel data in first and second data retaining units;
alternately switching the first or second data retaining unit defined as a write destination of the decompressed pixel data;
alternately switching the first or second data retaining unit defined as a readout source of pixel data such that the pixel data are read out from the first or second data retaining unit not defined as the write destination of the pixel data;
outputting the pixel data read from the first or second data retaining unit; and
referring to the pixel data read out from the first or second data retaining unit not defined as the write destination of the decompressed pixel data when decompressing the acquired compressed pixel data on the basis of the blocks.
